(19) United States
(12) Patent Application Publication
(10) Pub. No.: US 2025/0222382 A1
(43) Pub. Date: Jul. 10, 2025

(54) Air Filter with Life Timing

(71) Applicant: Prime IP Asset Organization, LLC, Dawsonville, GA (US)

(72) Inventor: John David Mechwart, Cumming, GA (US)

(73) Assignee: Prime IP Asset Organization, LLC, Dawsonville, GA (US)

(21) Appl. No.: 18/408,511

(22) Filed: Jan. 9, 2024

(51) Int. Cl. B01D 46/00; B01D 46/10; B01D 46/62

(52) U.S. Cl. CPC B01D 46/0086; B01D 46/0043; B01D 46/0049; B01D 46/10; B01D 46/645; B01D 2273/30

(57) ABSTRACT

An air filter with a life timing feature includes a filter body and a mounted detachable filter grille. The filter grille's life timing is monitored by a life timing device, which consists of a limit frame on the filter body, a first induction piece, a second induction piece, and a timer electrically connected to the first induction piece. The first induction piece is connected to the limit frame, while the second induction piece is hinged to the first induction piece. The second induction piece is positioned on the outer side of the limit frame and interacts with a sensing part within the first induction piece. When the detachable filter grille is mounted on the limit frame and engages with the pressure plate of the second induction piece, the second induction piece engages with the sensing part, activating the timer to initiate the life timing of the filter grille.

### TECHNICAL AREA

The utility model relates to the field of air filters, in particular to an air filter having a life timing.

### BACKGROUND

With the rapid improvement of the national economic level, more and more people pay more attention to the improvement of the quality of life, at the same time, they also put forward higher and higher requirements for environmental standards and advocate breathing fresh, green and pollution-free air. Therefore, the air filter is more and more favored by people.

The existing air filter generally includes the filter box, the filter box is installed in the fan, the fan will be inhaled after the external wind filter emissions, the general filter box can be removed and installed with a replaceable filter grille, the filter grille has a certain life, need to be replaced regularly. The replacement of the existing filter grille is generally through the user's own feeling, if the customer forgets to replace or remember the wrong replacement time, the continued use of the filter grille without filter effect will affect the air filtration effect, the use of very inconvenient.

A problem to be solved by the utility model is to provide an air filter with life timing, so as to overcome the defect that the existing air filter cannot be life timed.

### SUMMARY OF THE INVENTION

In order to solve the technical problem, the utility model provides an air filter with life timing, which comprises a filter body, a filter grille which can be disassembled and installed at one end of the filter body and a life timing device for life timing of the filter grille. The life timing device comprises a limit frame fixed on the inner wall of the main body of the filter, an induction piece and an induction piece used in cooperation with each other and a timer connected with the induction piece control, the induction piece is installed on the inside of the limit frame, the induction piece is hinged on the induction piece. The induction plate is arranged on the pressure plate, the pressure plate is placed on the outer side of the limit frame. When used, the filter grille is mounted on the limit frame, the filter grille presses the pressure plate so that the induction sheet and the induction part create induction, so that the timer starts the life timing.

In some embodiments, one end of the induction part is provided with a contact induction part, and the contact plate corresponding to the contact induction part is provided on the induction sheet. When the contact plate is in contact with the contact induction part, the induction part activates the timer for timing. A torsion spring is arranged between the induction piece and the induction piece, and the torsion spring causes the contact plate to move in the direction away from the contact induction part.

In some embodiments, the induction piece is fixed on the inner wall of the filter body through the connecting piece, the connecting piece is symmetrically arranged on the first articulated piece, the induction piece is symmetrically arranged on the second articulated piece matched with the first articulated piece, the first articulated piece and the second articulated piece are rotatably hinged through a shaft. The pressure plate, the contact plate and the second hinged piece are metal pieces with an integrated structure, and the induction part is a magnetic control induction switch.

In other embodiments, the back end of the filter body is arranged around a limit buckle for limiting the filter grille.

In further embodiments, the filter body is provided with a display screen for displaying the timing time of the timer, and one side of the display screen is provided with an adjustment button for adjusting the life time.

In some embodiments, the filter body comprises a filter box and a fan installed in the filter box, the front end of the filter box is provided with an air inlet, the air inlet is installed on the first filter screen, the fan is connected with the air inlet. The rear side of the fan is installed with a second filter screen, the filter grating and the life timing device is located in the second filter screen behind the side. The upper end of the filter box is rotated and installed with a handle.

In some aspects, the techniques described herein relate to a method for life timing with an air filter including: providing a filter body; attaching a limit frame on an inner wall of the filter body; mounting a detachable filter grille adjacent one end of the filter body on the limit frame; coupling a first induction piece having a sensing part with the limit frame, and coupling a second induction piece via a hinge with the first induction piece; electrically coupling a timer with the sensing part of the first induction piece; coupling a pressure plate and contact plate to the second induction piece; responding to mounting the detachable filter grille by physically engaging the filter grille with the pressure plate of the second induction piece to engage the sensing part with the contact plate; and activating the timer to initiate life timing of the filter grille in response to engaging the sensing part with the contact plate.

In other aspects, the techniques described herein relate to a method further including: mounting a display on the filter body; coupling the timer to the display; and providing an indication of the life timing on the display.

In further aspects, the techniques described herein relate to a method further including: removing the detachable filter grille from the limit frame; in response to removing the detachable filter grille, physically disengaging the filter grille from the pressure plate of the second induction piece to disengage the sensing part of the first induction piece from the contact plate; and providing a signal to the timer to reset life timing of the filter grille in response to disengaging the first induction piece with the pressure plate.

In some aspects, the techniques described herein relate to an air filter with life timing including: a filter body; a detachable filter grille mounted adjacent one end of the filter body; a first induction piece coupled with the filter body and having a sensing part; a second induction piece coupled via a hinge with the first induction piece; the second induction piece operative to physically engage with the filter grille, and in response thereto the second induction piece operative to rotate on the hinge to engage the sensing part; a timer electrically coupled with the first induction piece; and the first induction piece operative to activate the timer to initiate life timing of the filter grille in response to the second induction piece engaging the sensing part.

In some aspects, the techniques described herein relate to an air filter with life timing, including: a display electrically coupled to the timer to indicate the life timing of the filter grille.

The utility model provides an air filter with life timing, which has one or more of the following advantages:

The life timing device is added, through the induction part and the induction piece, when replacing the new filter grille, the filter grille is installed on the limit frame, and the filter grille is pressed under the pressure plate to make the induction piece and the induction part contact to create induction, so as to control the timer to start the life timing and display on the display screen. The information of the display screen allows customers to understand the life time in real time and replace it in time. When the filter grille is removed after use, the pressure plate 501 disengages from the filter grill, the sensor piece induction piece is separated from the induction piece sensor piece, and the timer time is reset, which is convenient for the next use of timing.

Through the first filter, the second filter and the filter grid, the use of external air sequentially through the first filter, the second filter and the filter grid filter out, after multiple layers of filtration, filtering effect is good, a wide range of applications.

### DESCRIPTION OF THE DRAWINGS

In order to more clearly explain the technical scheme of the embodiments of this application, the following will be a brief introduction to the drawings required to be used in the embodiments. It is obvious that the drawings described below are only some embodiments of this application. For one of ordinary skill in the field, other drawings can be obtained according to these drawings without creative labor.

FIG. 1 is a stereogram of the front end of an air filter with life timing of the utility model;

FIG. 2 is a stereogram of the rear end of an air filter with life timing of the utility model;

FIG. 3 is an exploded view of an air filter with life timing of the utility model;

FIG. 4 is a stereogram of an air filter with life timing after removing the filter grating of the utility model;

FIG. 5 is the cutting diagram of an air filter with life timing of the utility model;

FIG. 6 is an internal stereogram of an air filter with life timing of the utility model;

FIG. 7 is a stereogram of an air filter with a life timing sensor connected with an induction piece of the utility model;

FIG. 8 is a stereogram of an air filter sensor with a life timing and an induction piece of the utility model connected with another perspective;

FIG. 9 is the exploded view of an air filter induction part and an induction piece of the utility model with a life timing; and

FIG. 10 is a flowchart of an example method for life timing with an air filter.

### DESCRIPTION OF THE PREFERRED EMBODIMENTS

The corresponding component names marked by each attached figure in the figures are: A main body of the filter, e.g., filter body 100, limit buckle 110, a display screen 120 (and timer—not shown), an adjustment button 130, a filter box 140, a fan 150, a first filter screen 160, a second filter screen 170, a rotatable handle 180, an air inlet 141, a filter grille 200, a limit frame 300, an induction piece 400 (also referred to as a first induction piece), a sensing part 401 (also referred to as a contact induction part or contact sensing part), an induction piece 500 (also referred to as a second induction piece), a torsion spring 600, a connecting piece 700, and a first hinged piece 701. Induction piece 500 includes a pressure plate 501, a contact plate 502, and a second hinged piece 503.

The following is a detailed description of the application in combination with the attached drawings and specific embodiments.

The following describes the implementation of this application through specific concrete examples, and personnel skilled in the field can easily understand other advantages and effects of this application from the contents disclosed in this specification. It is obvious that the embodiments described are only a part of the embodiments of this application and not the whole of the embodiments. This application may also be implemented or applied in other specific embodiments, and the details in this specification may be modified or altered in various ways, based on different points of view and applications, without deviating from the spirit of this application.

It should be noted that the following embodiments and the features in the embodiments may be combined with each other without conflict. Based on the embodiments in this application, all other embodiments acquired by a person of ordinary skill in the art without creative labor fall within the scope of protection of this application.

It should be noted that the various aspects of the embodiments within the scope of the attached claims are described below. It should be clear that the aspects described herein may take a wide variety of forms and that any particular structure and/or function described herein is illustrative only. On the basis of this application, persons skilled in the field concerned should be aware that one aspect described herein may be implemented independently of any other aspect and that both or more of these aspects may be combined in various ways. For example, equipment and/or practices may be implemented using any of the numbers and aspects described herein. In addition, the equipment and/or the method may be implemented using structures and/or functionality other than one or more of the aspects described herein.

It should also be noted that the diagrams provided in the following embodiments are only illustrative of the basic idea of the present application, and only the components related to the present application are shown in the diagram rather than drawing according to the number, shape and size of the components in actual implementation. The type, quantity and proportion of the components in an actual implementation may be changed at will, and the layout of the components may also be more complex.

In addition, in the following description, specific details are provided to facilitate a thorough understanding of the examples. However, those skilled in the field will understand that it can be practiced without these specific details.

The technical solutions provided in the embodiments of this application are illustrated below in conjunction with the attached drawings.

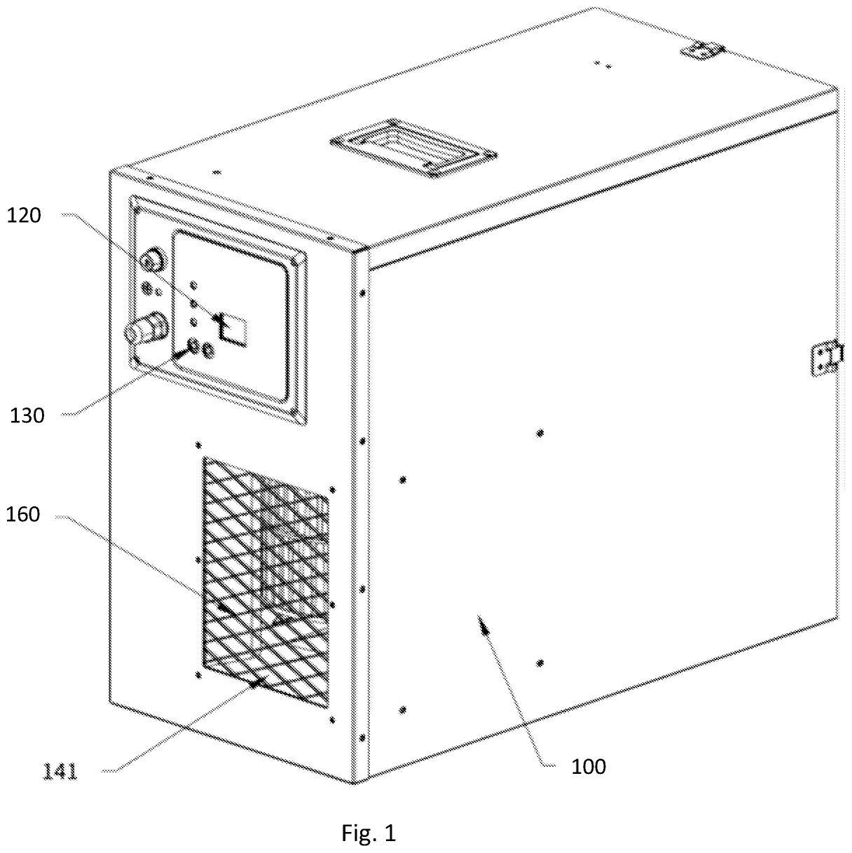

Referring to FIGS. 1 to 9, the utility model provides an air filter with life timing, which comprises filter body 100, a detachable filter grille 200 mounted at one end of the filter body 100 (and held in place with limit buckle 110) and a life timing device for life timing of the filter grille 200.

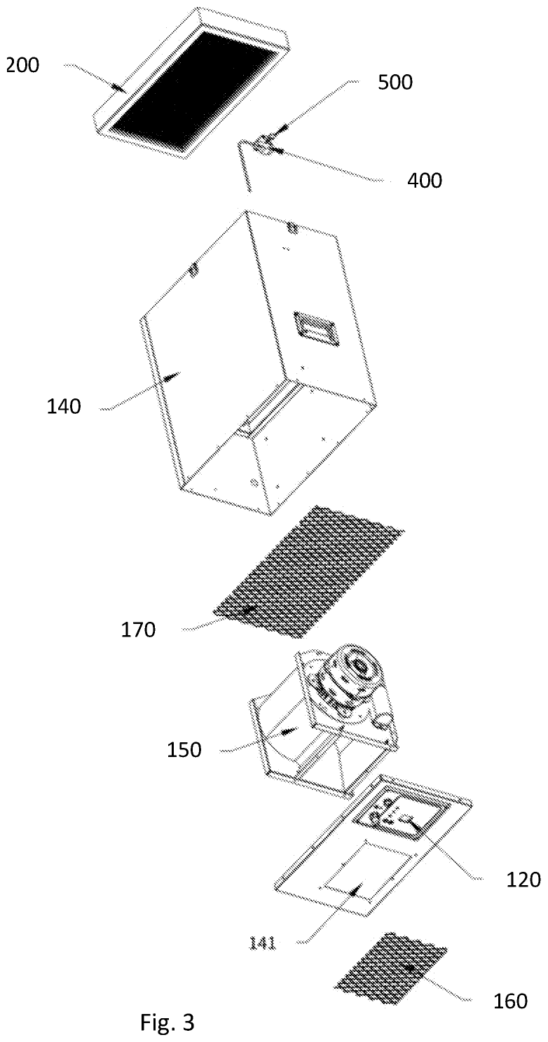

Referring to FIGS. 3-5, and 7, the life timing device comprises a limit frame 300 fixed on an inner wall of the filter body 100, a first induction piece 400 and a second induction piece 500 used in conjunction/cooperation with each other, and an electronic timer triggered by the induction piece 400. The induction piece 400 is mounted on an inner wall of an outer side of the limit frame 300. The induction piece 500 is hinged to induction piece 400. The timer is mounted on the front end of the filter body 100 or adjacent display screen 120. The induction piece 400 connects with the timer through a connecting line or wire. Pressure plate 501 is arranged on the second induction piece 500 and is placed on the outside of the limit frame 300.

When replacing the filter grille 200, the filter grille 200 is installed on the limit frame 300, and the filter grille 200 presses the pressure plate 501 to rotate the induction piece 500 towards the induction piece 400. In response the induction piece 500 contacts and/or engages with the induction piece 400, so that the induction piece 400 activates the timer to initiate the life timing of the timer.

When disassembling the filter grille 200 after use, an orientation of pressure plate 501 is reset under the action of the torsion spring 600. During disassembly the pressure plate 501 of second induction piece 500 is separated from the first induction piece 400, and the timer is reset to facilitate a new life timing cycle.

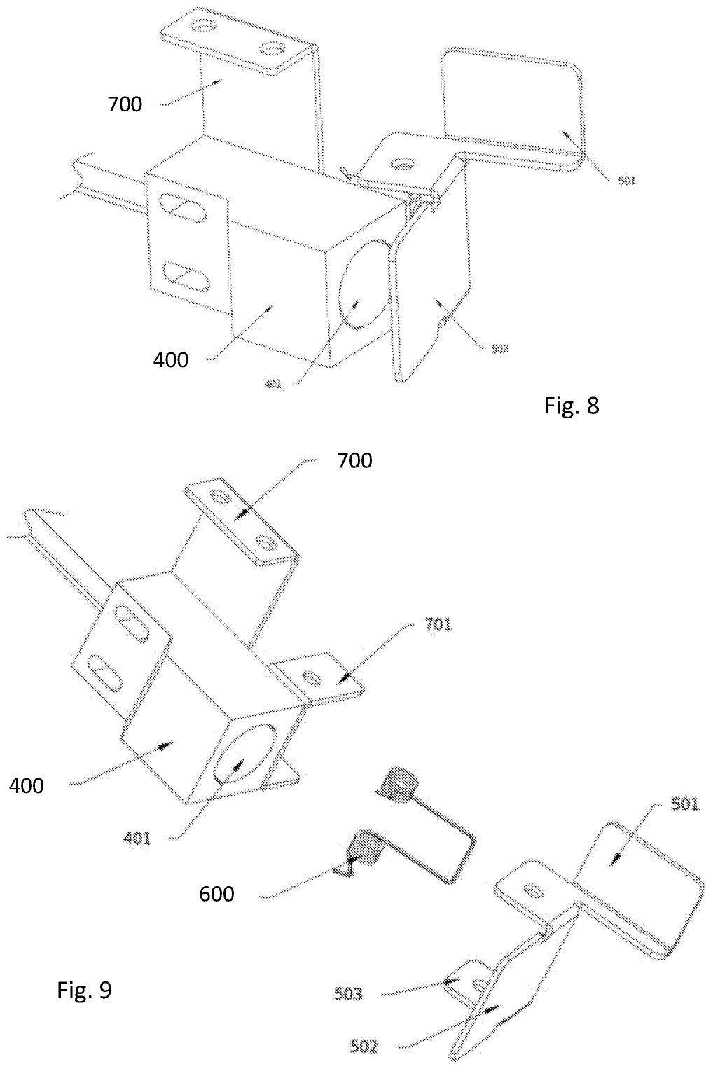

In some embodiments, as shown in FIG. 7 and FIG. 8, one end of the induction piece 400 is provided with a contact sensing part 401, and a contact plate 502 corresponding to the contact sensing part 401 is provided on the induction piece 500. When the contact plate 502 is in contact (or in close proximity) with the contact sensing part 401, induction piece 400 completes a circuit to send a signal to the timer to initiate the life timing. When contact plate 502 is detached from the contact sensing part 401, the timer resets the life timing of the timer. Timer may include a backup power source, such as a battery. Timer may also be electrically connected to the fan (and sense fan activity) such that the timer only activates the life timer when the fan is running.

A torsion spring 600 is installed between the sensing part 401 and the induction piece 500. The torsion spring 600 applies pressure to cause the contact plate 502 to move in a direction away from the contact sensing part 401. The torsion spring 600 is used to reset the induction piece 500.

In some embodiments, as shown in FIG. 7 to FIG. 9, the induction piece 400 is fixed on the inner wall of the filter body 100 by connecting piece 700. The first hinged piece 701 is symmetrically arranged at a 90 degree angle on connecting piece 700, and the second hinged piece 503 is symmetrically arranged at a 90 degree angle on the induction piece 500 so that a surface of second hinged piece 503 lies in a plane parallel to a surface of the first hinged piece 701, to enable the second hinged piece 503 to mate with the first hinged piece 701. The first hinged piece 701 and the second hinged piece 503 are rotatably hinged together by a shaft (not shown in the figure) extending through apertures in first hinged piece 701 and second hinged piece 503. The rotating shaft also extends through the torsion spring 600.

Pressure plate 501, the contact plate 502 and the second hinged piece 503 are preferably metal sheets of integrated structure. Contact sensing part 401 within induction piece 400, in one implementation, includes a magnetic control induction switch that completes an electric circuit when activated. Magnetic control induction switch may be activated in response to the presence of a metal sheet or plate such as contact plate 502.

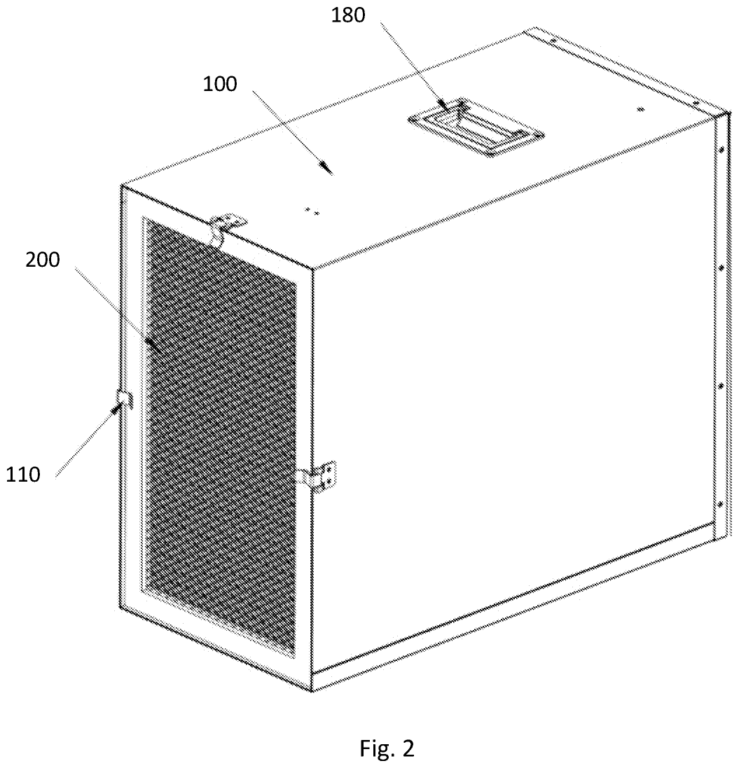

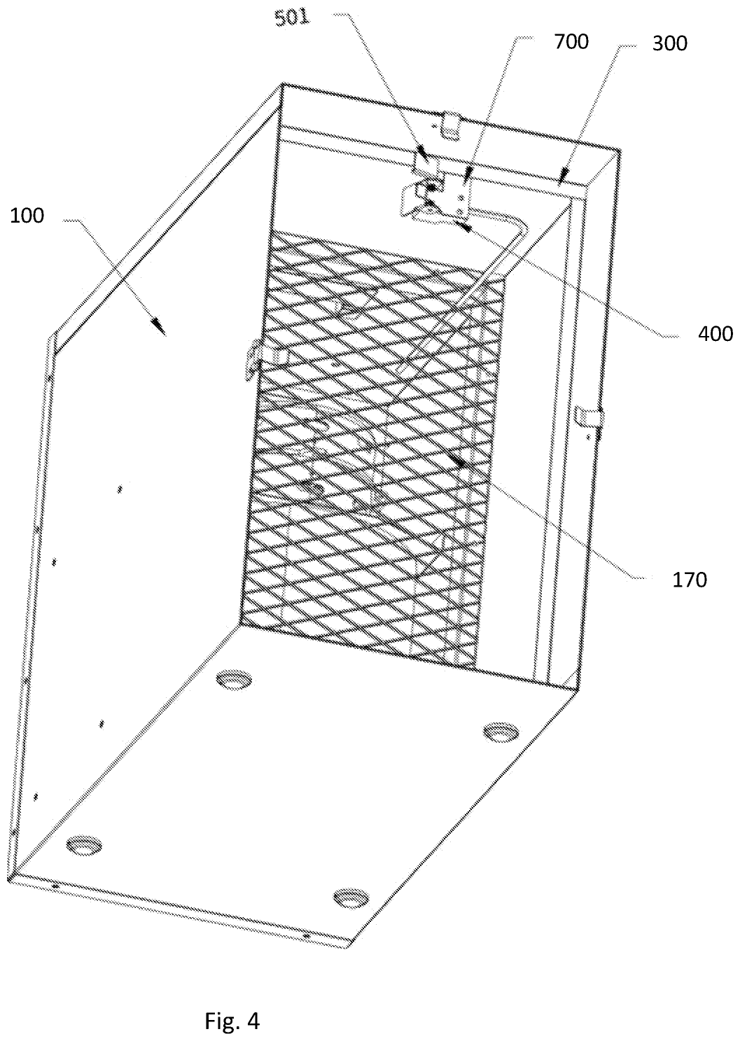

In some embodiments, as shown in FIGS. 2 and 4, the rear end of the filter body 100 is arranged around the limit buckle 110 for the limiting movement of filter grille 200, through which the filter grille 200 is mounted against the limit frame 300. The limit buckle 110 construction is generally known, which will not be repeated herein, and the limit buckle 110 can be rotated open to enable removal of the filter grille 200.

In one example, as shown in FIG. 1, a display screen 120 for displaying the life time of the timer is arranged on the filter body 100. The timer may be electrically connected on a circuit adjacent to the display screen 120. An adjustment button 130 for manual adjustment the life time may be arranged on one side of the display screen 120. By positioning the display screen 120 on filter body 100, the life timing can be displayed on the display screen 120 in real time. The adjustment button 130 can reset the replacement cycle/life timing for the filter grille 200 and can also set an audio or visual alarm. Specifically, when the timer reaches the end of a predetermined replacement cycle of the filter grille, the alarm can trigger.

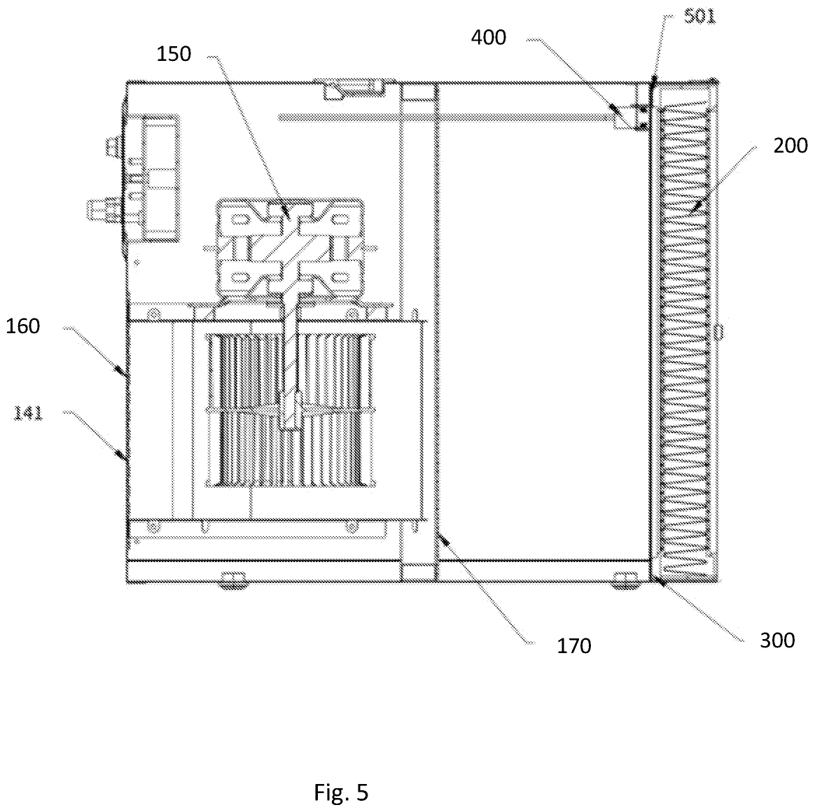

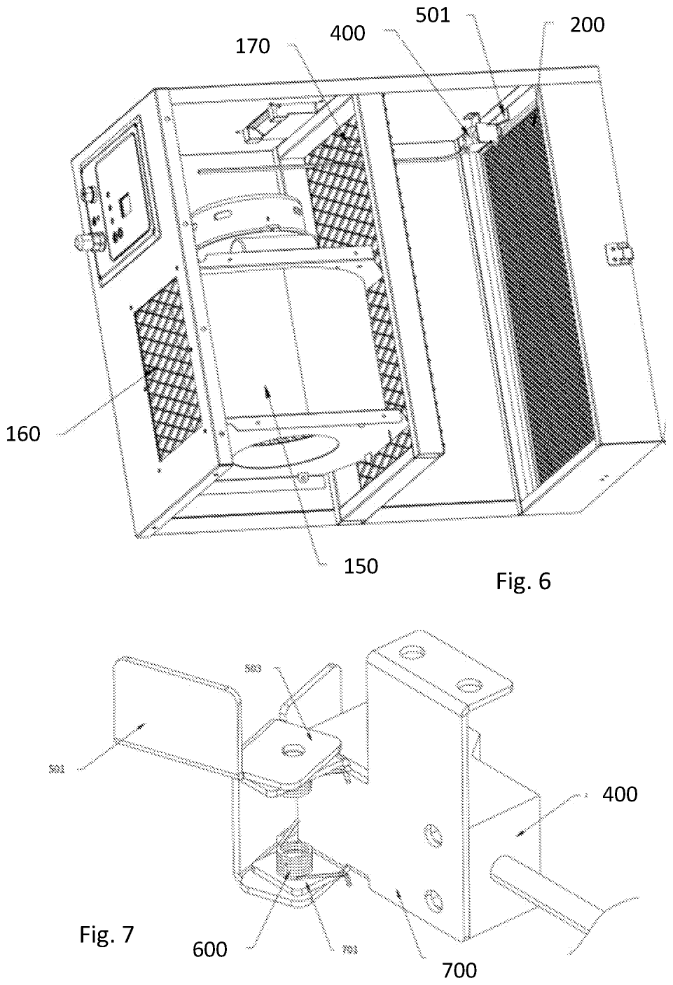

In one example, as shown in FIG. 3, FIG. 5 and FIG. 6, the filter body 100 comprises the filter box 140 and the fan 150 installed in the filter box 140. A front end of the filter box 140 is provided with an air inlet 141. The air inlet 141 may be installed with the first filter screen 160. The fan 150 draws air from the air inlet 141 across first filter screen 160. A second filter screen 170 is installed on the rear side of the fan 150. In one implementation, the filter grille 200, induction piece 400, induction piece 500 and the life timing device are located on a rear portion/side of the second filter screen 170 within filter box 140. The upper end of the filter box 140 may be installed with a rotatable handle 180 to manually move filter box 140.

When in use, fan 150 starts the external air flowing into the filter box 140. The external air blows across the first filter screen 160, the second filter screen 170, and out of filter box 140 via filter grille 200. By changing and/or cleaning one or more of the first filter screen 160 and/or second filter screen 170, and/or filter grille 200 upon an alarm or after a predetermined time/cycle of the life time shown on the display screen 120, the use of multi-layer filtration, filtration effect remains acceptable.

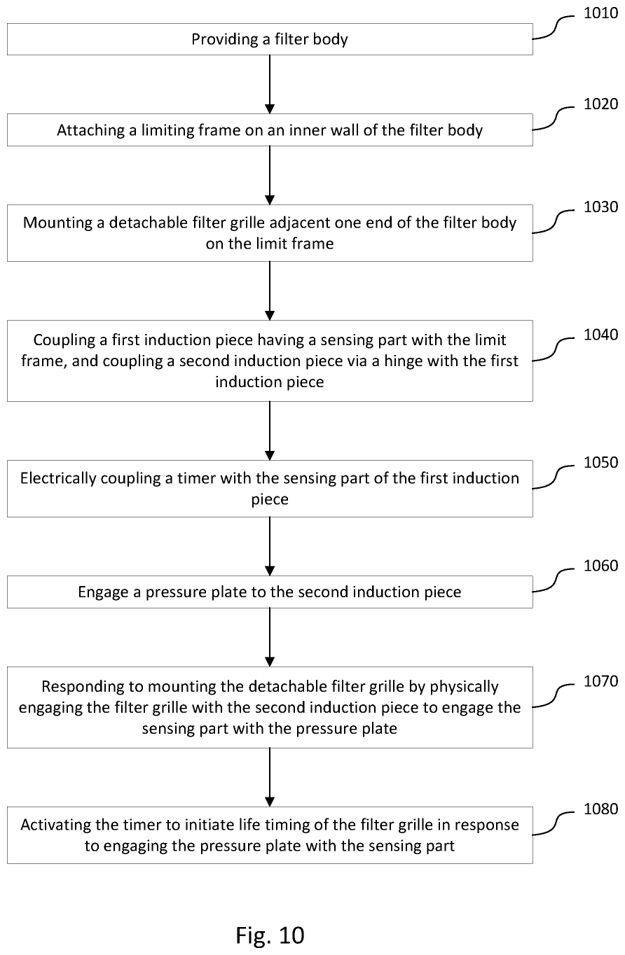

FIG. 10 is a flowchart of an example method for life timing with an air filter. The exemplary process in FIG. 10 is illustrated as a collection of blocks in a logical flow diagram, which represents a sequence of operations that can be implemented using the hardware described in FIGS. 1-9. The order in which the operations are described is not intended to be construed as a limitation, and any number of the described blocks can be combined in any order and/or in parallel to implement the process. For discussion purposes, the processes are described with reference to FIG. 10, although it may be implemented in other system architectures.

Referring to FIG. 10, at step 1010, the filter body 100 is provided.

At step 1020, a limit frame 300 is attached to an inner wall of the filter body 100.

At step 1030, detachable filter grille 200 is mounted adjacent one end of the filter body 100 on the limit frame 300.

At step 1040, a first induction piece 400 having a sensing part 401 is coupled with the limit frame 300, and a second induction piece 500 is coupled via a hinge with the first induction piece 400.

At step 1050, a timer is electrically coupled with the first induction piece 400.

At step 1060, contact plate 502 of the second induction piece 500 is engaged with sensing part 401 of the first induction piece 400.

At step 1070, in response to mounting the detachable filter grille 200 on the limit frame 300, the filter grille 200 physically engages with the pressure plate 501 of the second induction piece 500 resulting in the contact plate 502 of the second induction piece engaging with the sensing part 401 to initiate life timing by the timer.

At step 1080, the timer is activated to initiate life timing of the filter grille 200 in response to the contact plate 502 of the second induction piece 500 engaging with sensing part 401.

In another step (not shown), a display screen 120 is electrically coupled to the timer to indicate the life timing of the filter grille 200. Also in another step, the filter grille 200 can be manually removed from the limit frame 300. In response to removing filter grille 200, the filter grille 200 physically disengages with pressure plate 501 of induction piece 500 to disengage contact plate 502 from sensing part 401 of induction piece 400. A signal may then be fed (such as opening a circuit) from sensing part 401 to the timer to reset life timing of filter grille 200.

The same and similar parts between the various embodiments in this specification can be referred to each other, and each embodiment focuses on the difference with other embodiments.

The above are only the specific embodiments of this application, but the scope of protection of this application is not limited to this. Any change or replacement that can easily be thought of by a technical person familiar with the technical field within the technical scope disclosed in this application shall be covered by the scope of protection of this application. Therefore, the scope of protection in this application shall be subject to the scope of protection claimed by the rights.

What is claimed:

1. An air filter with life timing comprising:
a filter body;
a detachable filter grille mounted adjacent one end of the filter body;
a life timing device for the life timing of the filter grille, the life timing device comprising a limit frame fixed on an inner wall of the filter body, a first induction piece and a second induction piece used in cooperation with each other, and a timer electrically coupled with the first induction piece;
the first induction piece coupled with the limit frame, and the second induction piece coupled via a hinge with the first induction piece;
the second induction piece disposed on an outer side of the limit frame and operative to engage with a sensing part within the first induction piece; and
the detachable filter grille mounted on the limit frame to physically engage with a pressure plate of the second induction piece resulting in the second induction piece engaging with the sensing part to activate the timer to initiate life timing of the filter grille.

2. The air filter with life timing as described in claim 1, wherein one end of the first induction piece includes the sensing part, and wherein one end of the second induction piece includes a contact plate, and wherein the first induction piece is operative to initiate the timer in response to the contact plate engaging with the sensing part.

3. The air filter with life timing as described in claim 2, further comprising a torsion spring installed between the first induction piece and the second induction piece, such that the torsion spring is operable to move the contact plate in a direction away from the sensing part.

4. The air filter with life timing as described in claim 3, wherein the first induction piece engages an inner wall of the filter body through a connecting piece, wherein the first induction piece includes a first hinged piece, wherein the second induction piece includes a second hinged piece that mates with the first hinged piece, and wherein the first hinged piece and the second hinged piece mate by rotatably hinged together with a shaft.

5. The air filter with life timing as described in claim 4, wherein the pressure plate, the contact plate and the second hinged piece are integrally coupled metal sheets, and wherein the sensing part of the first induction piece includes a magnetic control induction switch operative to be activated in response to contact plate being disposed in close proximity to the sensing part.

6. The air filter with life timing as described in claim 1, wherein a rear end of the filter body is connected to a limit buckle to limit movement of the filter grille.

7. The air filter with life timing as described in claim 1, wherein the filter body couples to a display screen to display a life time of the timer, and an adjustment button couples to the display screen to enable manual adjustment of the life time of the timer.

8. The air filter with life timing as described in claim 1, wherein the filter body comprises a filter box and a fan installed in the filter box, and wherein a front end of the filter box includes an air inlet, and wherein a first filter screen is installed in the air inlet, and wherein the fan draws air via the first filter screen and the air inlet into the filter box.

9. The air filter with life timing as described in claim 8, wherein a second filter screen is disposed adjacent a rear of the fan, and wherein the filter grille, the first induction piece and the second induction piece are disposed at a rear portion of the second filter screen.

10. The air filter with life timing as described in claim 8, wherein an upper end of the filter box is installed with a rotatable handle.

11. A method for life timing with an air filter comprising:
providing a filter body;
attaching a limit frame on an inner wall of the filter body;
mounting a detachable filter grille adjacent one end of the filter body on the limit frame;
coupling a first induction piece having a sensing part with the limit frame, and coupling a second induction piece via a hinge with the first induction piece;
electrically coupling a timer with the sensing part of the first induction piece;
coupling a pressure plate and a contact plate to the second induction piece;
responding to mounting the detachable filter grille by physically engaging the filter grille with the pressure plate of the second induction piece to engage the sensing part with the contact plate; and
activating the timer to initiate life timing of the filter grille in response to engaging the sensing part with the contact plate.

12. The method as recited in claim 11 further comprising:
mounting a display on the filter body;
coupling the timer to the display; and
providing an indication of the life timing on the display.

13. The method as recited in claim 11 further comprising:
removing the detachable filter grille from the limit frame;
in response to removing the detachable filter grille, physically disengaging the filter grille with the pressure plate of the second induction piece to disengage the contact plate of the second induction piece from the sensing part; and
providing a signal to the timer to reset life timing of the filter grille in response to disengaging the contact plate of the second induction piece from the sensing part.

14. An air filter with life timing comprising:
a filter body;
a detachable filter grille mounted adjacent one end of the filter body;
a first induction piece coupled with the filter body and having a sensing part;
a second induction piece coupled via a hinge with the first induction piece;
the second induction piece operative to physically engage with the filter grille, and in response thereto the second induction piece operative to rotate on the hinge to engage the sensing part;
a timer electrically coupled with the first induction piece; and
the first induction piece operative to activate the timer to initiate life timing of the filter grille in response to the second induction piece engaging the sensing part.

15. The air filter with life timing as recited in claim 14, comprising:
a display electrically coupled to the timer to indicate the life timing of the filter grille.
